(19) United States
(12) Patent Application Publication
(10) Pub. No.: US 2024/0261995 A1
(43) Pub. Date: Aug. 8, 2024

(54) SLICING MACHINE

(71) Applicant: MULTIVAC SEPP HAGGENMÜLLER SE & CO. KG, Wolfertschwenden (DE)

(72) Inventor: Hans Christian WEISS, Dillenburg (DE)

(73) Assignee: MULTIVAC SEPP HAGGENMÜLLER SE & CO. KG, Wolfertschwenden (DE)

(21) Appl. No.: 18/435,076

(22) Filed: Feb. 7, 2024

(30) Foreign Application Priority Data
Feb. 8, 2023 (DE) 102023103039.6

(51) Int. Cl. B26D 7/22; B26D 7/06

(52) U.S. Cl. CPC B26D 7/225; B26D 7/0633

(57) ABSTRACT

In order to avoid complex electronic synchronization of various supply modules of an entire supply unit engaging on a caliber, the individual supply modules do not have separate drives, but rather a supply drive, usually a controllable electric motor, is mechanically operatively connected to several, preferably all existing, supply modules. As a result, moveable parts of the supply modules, which effect transport of the caliber in a supply direction, are driven accordingly.

### CROSS-REFERENCE TO RELATED APPLICATIONS

This application claims foreign priority benefits under 35 U.S.C. § 119(a)-(d) to German patent application number DE 10 2023 103 039.6, filed Feb. 8, 2023, which is incorporated by reference in its entirety.

### TECHNICAL FIELD

The disclosure relates to slicing machines, in particular so-called slicers, with which strands of a limitedly compressible product, such as sausage or cheese, are cut into slices in the food industry.

### BACKGROUND

As these strands can be produced with a cross section that retains its shape and dimensions well over their length, i.e., an essentially constant cross section, they are called product calibers.

Usually, several product calibers arranged parallel to each other are sliced simultaneously by cutting off one slice at a time from the same blade, which moves in a transverse direction to the longitudinal direction of the product calibers.

The product calibers are pushed forward by a supply conveyor in the form of a drivable supply belt, which forms one of several supply modules of a supply unit, in the direction of the cutting unit, wherein the supply conveyor is usually directed obliquely downwards. The product calibers are each supplied through a product opening of a plate-shaped cutting frame, at the front end of which the protruding part of the product caliber is cut off as a slice by the blade directly in front of the cutting frame.

The slices usually fall onto a discharge conveyor of a discharge unit, by means of which they are transported away for further processing.

During slicing, the product calibers are usually held at their rear end facing away from the cutting frame by a gripper of a gripper unit—which forms a further supply module—which is provided with activatable gripper claws for this purpose.

In addition, on the movement path of the product caliber, close to the cutting unit, usually directly upstream of the cutting frame, a so-called upper and/or lower product guide as at least one further supply module is provided.

In each case, this is a circulating traction belt that can be driven in the supply direction, which, in the case of the upper product guide, is arranged above the movement path of the caliber and engages on its upper side and, in the case of the lower product guide, is arranged below the movement path of the caliber and engages on its underside.

By means of these product guides, the respective caliber is moved forward in the supply direction between the cutting processes by a distance that corresponds to the desired target slice thickness. Compression or expansion of the caliber in the area from the product guides to the rear product gripper, which may be several meters away, does not affect the slice thickness.

In order to reload the slicer with new product calibers, the supply conveyor can usually be folded down from the inclined slicing position into a horizontal loading position for easier loading.

This can be done while the rest of the product caliber(s)—held and transported by the grippers and, if necessary, by the at least one product guide—is still being sliced.

Once this has been done, the end piece that can no longer be sliced is removed from the grippers, which move away from the cutting unit to their initial position at a maximum distance from it, so that when the newly loaded supply conveyor is subsequently swiveled upwards, the grippers will be located behind the rear ends of the new product calibers again and can grip them.

The problem here is that the gripper unit on the one hand, the supply belt on the other and also the drivable product guides each have their own drives, partly because they are located far away from each other, and partly because, if possible, the drive should be placed outside the contamination-intensive area around the cutting unit.

At first glance, one argument against a common drive for all supply modules by means of mechanical coupling is that not all operating situations require a synchronous movement of all supply modules in the supply direction.

For example, after the supply belt has been reloaded and folded up into the slicing position, the gripper unit is moved in the supply direction while the calibers are supported on a front stop, which can be a separate stop or one of the two product guides swiveled into a stop position.

In this situation, a synchronous movement of the product guides—if these are already in contact with the caliber—is undesirable, and even more so a synchronous movement of the supply belt.

### SUMMARY

It is therefore an object of the disclosure to provide a slicing machine, in particular a slicer, the supply unit of which is simpler in design and which nevertheless has a high level of process reliability.

A generic slicing machine such as a slicer, with which one or more calibers are to be simultaneously cut into slices, comprises on the one hand a cutting unit with a blade and on the other hand a supply unit for the controlled supplying of the at least one caliber to be sliced to the cutting unit, as well as a control which controls this and, in addition, usually also other moveable parts of the slicing machine.

This supply unit comprises several supply modules, which individually or jointly supply the caliber to the cutting unit in a controlled manner.

Firstly, a gripper unit that can be driven in the supply direction with at least one gripper that holds the rear end of a caliber, i.e., the end facing away from the blade. If several calibers are to be sliced in parallel, a corresponding number of grippers is provided on the gripper unit.

A further supply module is a supply conveyor, usually drivable in the supply direction, with a supply belt on which the caliber rests, which transports it or allows it to slide in the direction of the cutting unit, and usually one or two further supply modules in the form of a lower and/or an upper drivable product guide.

Such a drivable product guide usually consists of a circulating conveyor belt as a traction belt, which, in the case of the upper product guide, is arranged above the caliber to be conveyed and engages on its upper side and, in the case of the lower product guide, is arranged below the caliber and engages on its underside.

If a lower product guide is provided in addition to the supply belt, the lower product guide is located downstream of the supply belt. The two product guides are generally located directly upstream of the cutting unit and, in particular, its cutting frame.

According to the disclosure, the drive trains of at least two, in particular at least three, in particular all drive trains of these supply drives are coupled by a mechanical operative connection.

Preferably, the supply modules, which contain the supply conveyor on the one hand and the lower product guide and the gripper unit on the other hand, and preferably only these two (the two modules with supply conveyor and gripper unit) or three supply modules, are driven by a common supply drive.

This is particularly advantageous if the slicer is loaded manually with new calibers, i.e., the calibers are placed manually on the supply conveyor and there is a separate, activatable stop against which their lower ends can be placed and this separate stop is not part of one of the driven supply modules.

The drive train is understood to be the operative connection from the drive source to the respective supply module, in each case including, wherein the drive source is usually an electric motor, in particular the part of the drive train directly connected to the part of this supply module to be driven.

Thus, several, in particular all, supply modules can be driven together from one supply drive, which reduces the number of drives and in particular drive motors and, above all, eliminates the need for complex electronic synchronization of several supply modules to the same supply speed. As a result, the mechanical design effort for the mechanical operative connection is greater, but the complexity of the control system is lower.

Ideally, there is therefore only one single supply drive, usually in the form of an electric motor, which drives all provided supply modules in the supply direction.

In order to be able to stop individual supply modules despite activation of the corresponding supply drive, a controllable clutch can be assigned to the individual supply module, with which this supply module can be decoupled from the common drive train by disconnecting the clutch.

Therefore, such a clutch is arranged in particular between the moveable part of the respective supply module and the connection point of its drive train with one of the other drive trains.

As a result, such a supply unit can be used much more flexibly and operated in a manner adapted to the respective processing situation.

Preferably, a specific supply module, the so-called primary supply module, e.g., the supply module with the lower product guide, is mechanically coupled non-detachably to the, usually only, supply drive, so that when the supply drive is activated, this primary supply module must also move. If one or more or, in particular, all supply modules other than this primary supply module are provided, a controllable clutch can be arranged between the respective supply module and the connection point of this supply module with the drive of another supply module in order to shut down the respective supply module by disconnecting the clutch, regardless of whether the supply drive is activated or not.

In terms of positioning, the motor of the supply drive is usually arranged upstream of the upper and/or lower product guide, and thus outside the cutting unit, which is highly susceptible to contamination. This makes it easier to keep the supply unit clean.

A belt drive system including one or more belt drives and a supply drive (e.g., electric motor) is preferably used as the mechanical operative connection between the drive trains of the various supply modules, as this is simple and cost-effective and yet—when using a toothed belt—operates without slip and, above all, the necessary transmission ratios are very easy to implement using such a belt drive system.

Preferably, the operative connection and in particular a corresponding belt drive is arranged on the anti-operator side of the modules facing away from the operator so as not to make it difficult to see into the machine.

A slip sensor is preferably provided on those supply modules that engage non-positively with a caliber, i.e., in particular by means of a conveyor belt or traction belt, with which any slip between the corresponding supply module and the caliber can be detected.

This makes it possible to detect whether the—mechanically synchronized—moveable parts of the supply modules are rubbing against the caliber, which should be avoided so as not to damage the caliber.

If slip occurs, it can then be checked whether either the frictional connection between the supply module and the caliber is too low or the relative speed of the caliber to the individual supply modules is different, for example due to expansion or compression processes in the caliber.

With regard to the method for operating a slicing machine such as a slicer having a supply unit with several supply modules, in particular for operating a slicing machine as described above, the present object is achieved in that the existing supply modules are not only driven in the supply direction, but several, preferably all existing, supply modules are driven from a common supply drive.

This ensures reliable synchronization by the mechanical drive starting from the common supply drive.

This avoids time-consuming electronic synchronization of several electric drives.

Preferably, the supply modules are decoupled in groups or individually from the common supply drive or coupled to it by means of a mechanical operative connection, depending on what is necessary for the current operating state of the slicing machine.

This makes it easy to adapt to different operating conditions.

### BRIEF DESCRIPTION OF THE DRAWINGS

Embodiments according to the disclosure are described in more detail below by way of example and with reference to the following drawings, which show:

FIGS. 1a, b: a known slicing machine in the form of a slicer according to the prior art in different perspective views, with the supply belt folded up into the slicing position,

FIG. 2a: a simplified side view of the known slicing machine according to FIGS. 1a, b, free of cladding elements, so that the individual conveyor belts can be recognized more easily, loaded with a product caliber,

FIG. 2b: a side view as illustrated in FIG. 2a, but with the supply belt folded down into the loading position and the product caliber cut open except for a caliber remnant,

FIG. 3a: an enlarged part of a side view as illustrated in FIG. 2a,

FIG. 3b: in a 1st construction form, the part of a side view marked in FIG. 3a, enlarged again in comparison, with a supply unit according to the disclosure with three supply modules driven by a common supply drive,

FIG. 3c: in a 2nd design, the part of a side view marked in FIG. 3a, enlarged again in comparison, with a supply unit according to the disclosure with four supply modules driven by a common supply drive, and

FIG. 4a-c: schematic diagrams of the drive trains of the supply modules of three different supply units.

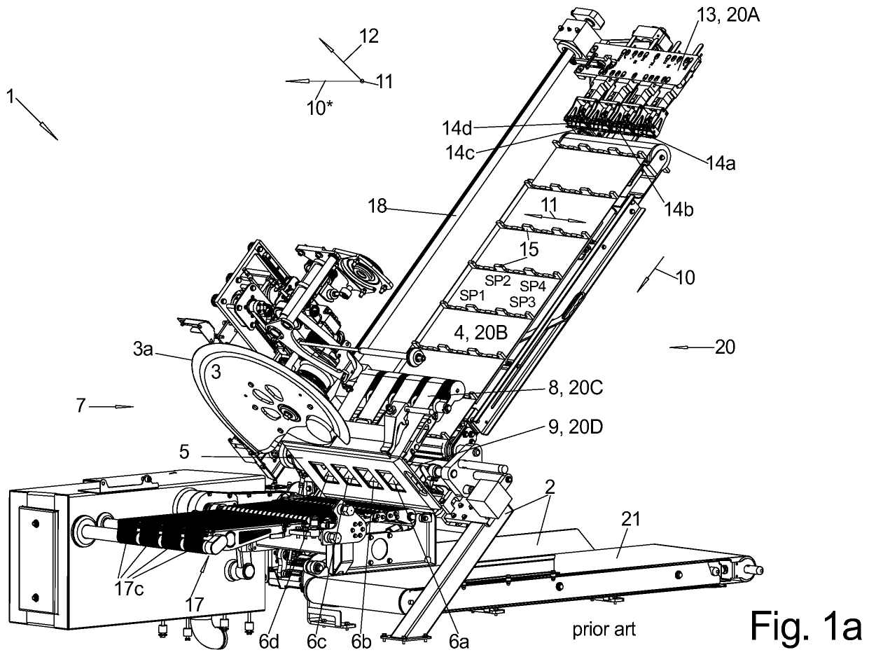

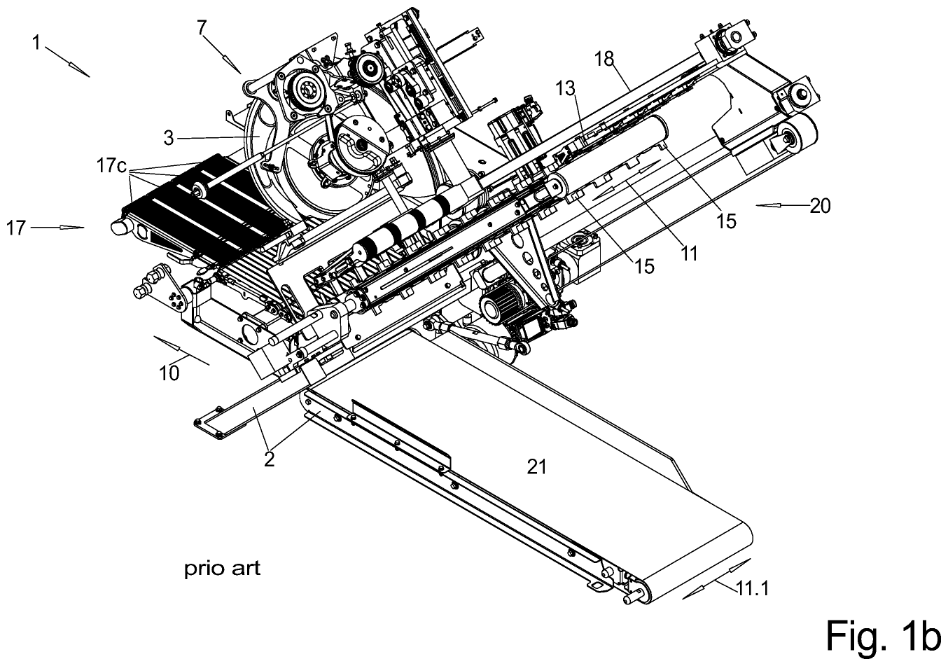

FIGS. 1a, 1b show different perspective views of a multi-track slicer 1, according to the prior art, for simultaneously slicing several product calibers K on one track SP1 to SP4 next to each other and depositing them in shingled portions P each consisting of several slices S with a general passage direction 10* through the slicer 1 from right to left.

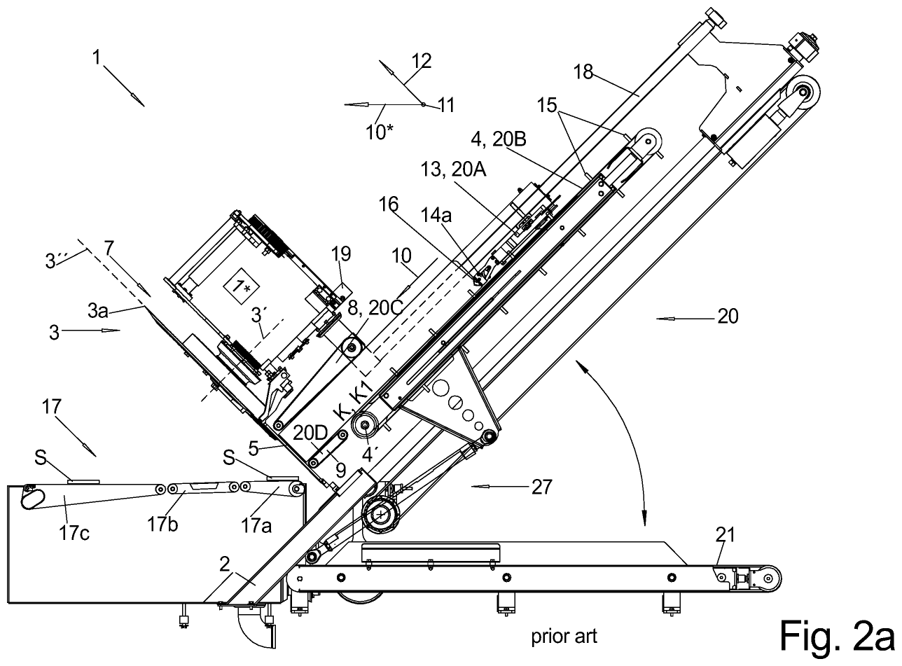

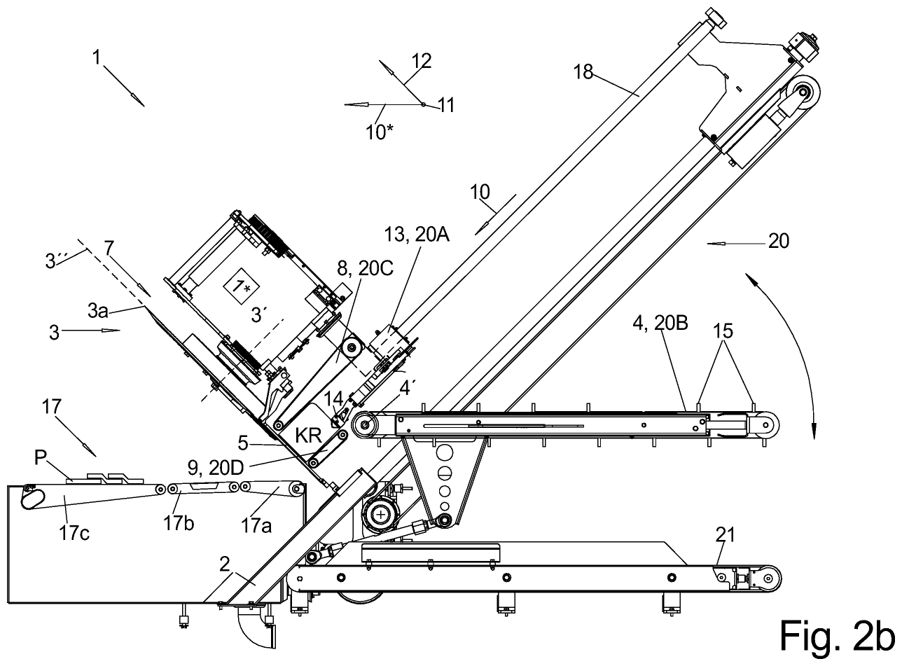

FIG. 2a illustrates—with inserted calibers K, of which only the caliber K1 closest to the viewer is visible in the direction of view—a side view of this slicer 1, omitting covers and other parts not relevant to the disclosure, which are attached to the base frame 2 just like all other units, so that the functional parts, in particular the conveyor belts, are easier to see. The longitudinal direction 10 is the supply direction of the calibers K to the cutting unit 7 and thus also the longitudinal direction of the calibers K lying in the slicer 1.

It can be seen that the basic structure of a slicer 1 according to the prior art is that a cutting unit 7 with a blade 3 rotating around a blade axis 3′, such as a sickle blade 3, is provided with several, in this case four, product calibers K lying next to one another in the 1st transverse direction 11 relative to the supply direction 10 on a supply conveyor 4 as supply module 20B of a supply unit 20 with spacers 15 of the supply conveyor 4 between the calibers K. The calibers K are supplied by this supply module 20B, and from the front ends of which the rotating blade 3 with its cutting edge 3a cuts off a slice S in each case in one operation, i.e., almost simultaneously.

For slicing the product caliber K, the supply conveyor 4 is in the slicing position illustrated in FIGS. 1a-2a, which is inclined in the side view, with the cutting-side front end lying low and the rear end lying high, from which it can be folded down about a pivot axis 4′ running in its width direction, the 1st transverse direction 11, which is located in the vicinity of the cutting unit 7, into an approximately horizontal loading position, as illustrated in FIG. 2b.

According to FIG. 2a, the rear end of each caliber K lying in the supply unit 20 is held positively by a gripper 14a-d with the aid of gripper claws 16. These grippers 14a-14d, which can be activated and deactivated with respect to the position of the gripper claws 16, are attached to a common gripper slide 13 as supply module 20A (of the supply unit 20), which can be tracked along a gripper guide 18 in the supply direction 10.

Both the supply of the gripper slide 13 and the supply conveyor 4 can be driven independently of each other, but the specific supply speed of the caliber K is effected by so-called upper and lower product guides 8, 9, which are also driven independently of each other as supply modules 20C, D of the supply unit 20 and which engage the top and bottom of the caliber K to be cut open in their front end sections near the cutting unit 7.

The front ends of the calibers K are each guided through a product opening 6a-d of a plate-shaped cutting frame 5, with the cutting plane 3″ extending directly in front of the front, downwardly inclined end face of the cutting frame 5, in which the blade 3 rotates with its cutting edge 3a and thus cuts off the protrusion of the calibers K from the cutting frame 5 as slices S. The cutting plane 3″ runs perpendicular to the upper run of the supply conveyor 4 and/or is spanned by the two transverse directions 11, 12 which are perpendicular to the supply direction 10.

The inner circumference of the product openings 6a-d serves as a counter-cutting edge of the cutting edge 3a of the blade 3.

Since both product guides 8, 9 can be driven in a controlled manner, in particular independently of each other and/or possibly separately for each track SP1 to SP4, these determine the—continuous or intermittent—supply speed of the calibers K through the cutting frame 5.

The upper product guide 8 can be displaced in the 2nd transverse direction 12—which is perpendicular to the surface of the upper run of the supply conveyor 4—to adapt to the height H of the caliber K in this direction. Furthermore, at least one of the product guides 8, 9 can be designed to be swiveling about one of its deflecting rollers in order to be able to change the direction of the run of its guide belt in contact with the caliber K to a limited extent.

The slices S standing at an angle in the space during separation fall onto a discharge device 17 starting below the cutting frames 5 and running in the passage direction 10*, which in this case consists of a plurality of discharge units 17a, b, c arranged approximately in alignment one behind the other with the upper runs of their conveyor belts, of which the first discharge unit 17a in the passage direction 10* can be designed as a portioning belt unit 17a and/or can also be designed as a weighing unit.

The slices S can impinge on the portioning belt unit 17a individually and spaced apart from one another in the passage direction 10* or, by appropriate control of this portioning belt 17a of the discharge conveyor 17—the movement of which, like almost all moveable parts, is controlled by the control or control unit 1*—form shingled or stacked portions P by stepwise forward or backward movement of the portioning belt 17a. In that regard, as one skilled in the art would understand, the control 1*, as well an any other unit, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

Below the supply unit 20 usually an approximately horizontal end piece conveyor 21 is provided, which starts with its front end below the cutting frame 5 and directly below or behind the discharge unit 17 and with its upper run transports the pieces falling onto it—by means of the drive of at least one of the discharge units 17a, b, c against the passage direction 10*—to the rear.

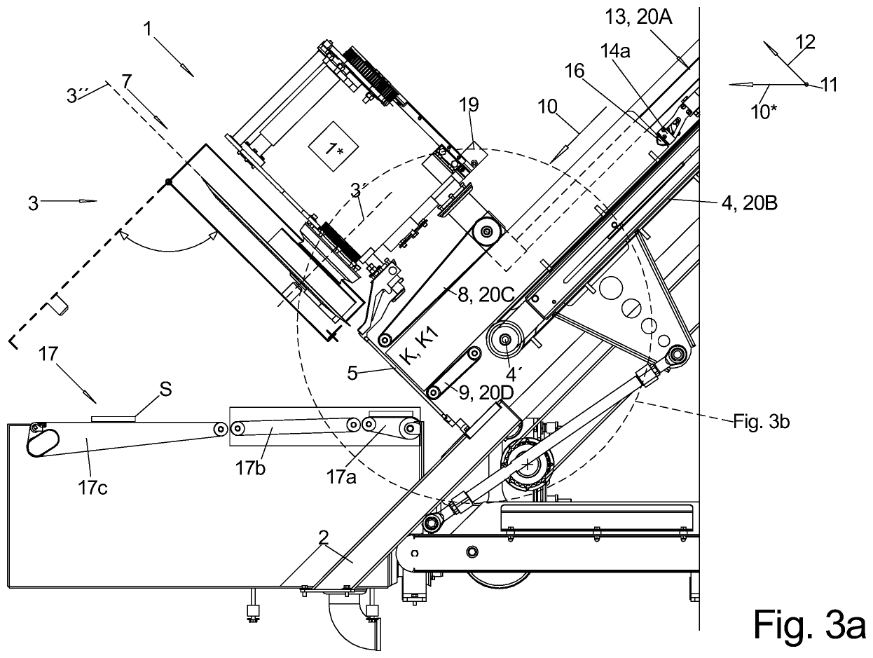

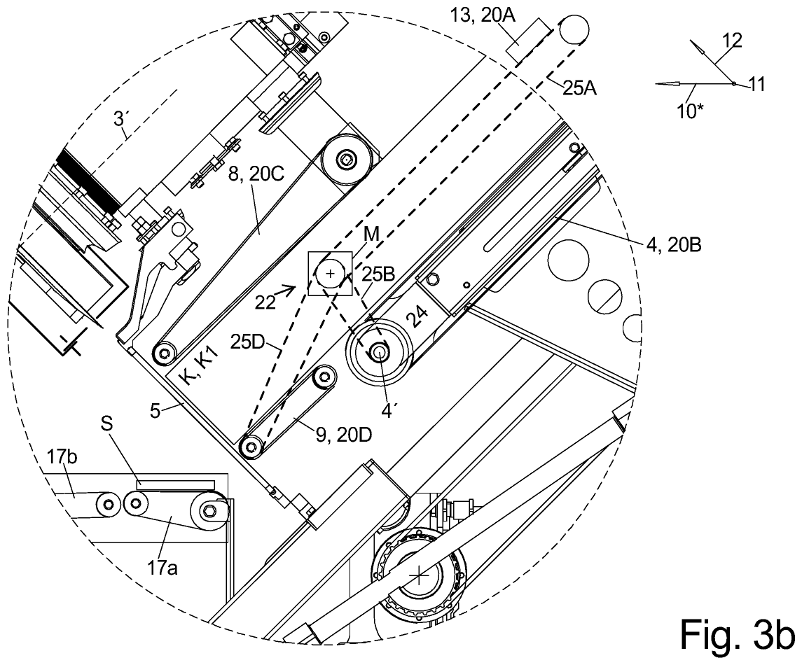

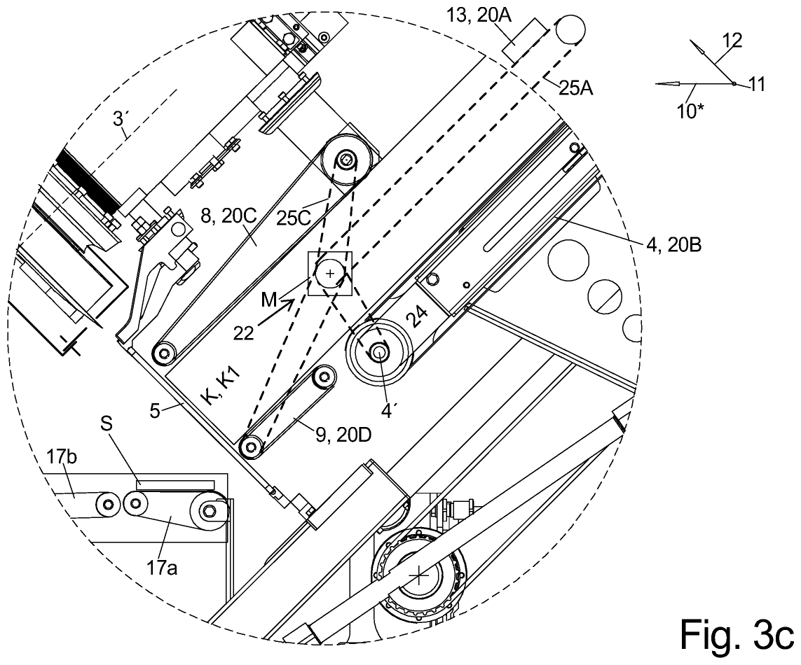

FIG. 3b illustrates an enlarged side view of a first design of a supply unit 20 according to the disclosure compared to FIG. 3a.

Here, the supply modules 20A, 20B, 20D are driven by a common supply drive 22 comprising a motor M, namely via a respective belt drive 25A, 25B, 25D.

Of course, the supply modules could be driven by the supply drive 22 in a series connection instead of via belt drives driven directly by the motor and/or its transmission, i.e., a first supply module driven by the supply drive 22, a second supply module driven by the first supply module, and a third supply module driven by the second driven supply module, i.e., serial arrangement instead of parallel arrangement of the individual module-specific drive trains.

The same also applies to FIG. 3c, which illustrates a second design of the supply unit 20 according to the disclosure and differs from FIG. 3b in that a fourth supply module 20C and thus all existing supply modules are also driven by the common supply drive 22.

In both FIGS. 3b, c, a slip sensor 24 is illustrated—as an example on only one supply module 20B, namely the supply conveyor 4—with which slip between this drive module and the caliber K to which it is connected can be detected.

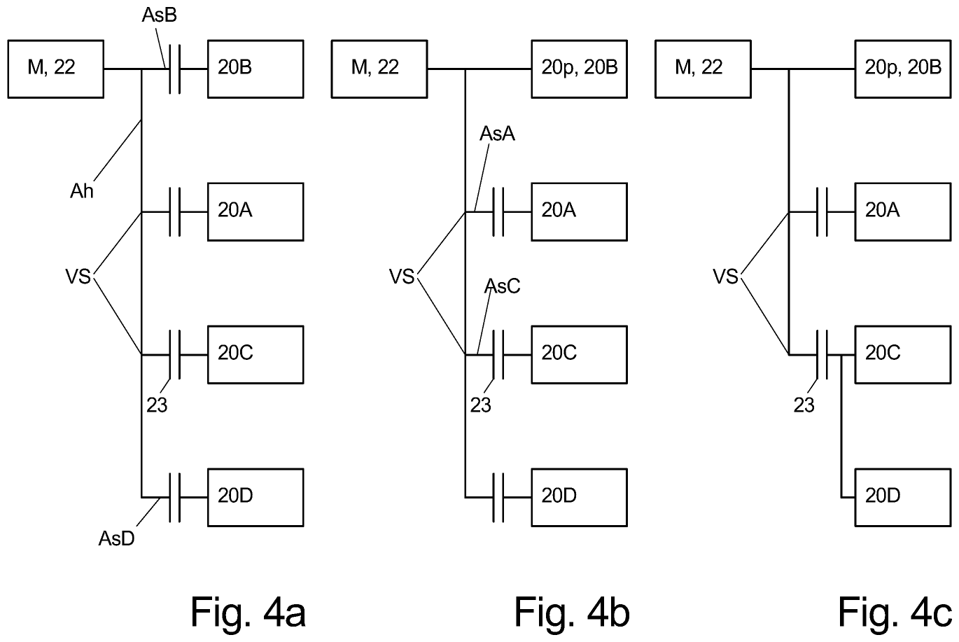

FIG. 4a illustrates a supply unit 20 with a single supply drive 22, here for example in the form of a mostly electric motor M, which drives all supply modules 20A to 20D, i.e., effects the transport of the respective caliber contacted by this module in the supply direction 10.

This supply drive 22 can drive all supply modules 20A to 20D in or, in particular, also in the opposite direction to the supply direction 10.

For this purpose, the supply drive 22 drives a main drive train Ah, to which the module-specific drive trains As, i.e., in this case AsA-AsD of the individual supply modules 20A to 20D, are operatively connected, in particular branching off from it.

In FIG. 4a, a controllable clutch 23 is provided in each of the module-specific drive trains AsA-AsD, i.e., between the respective connection point VS of the module-specific drive train with one of the other drive trains and the respective module, in order to be able to shut down each of the modules 20A to 20D individually and independently of one another, regardless of whether the supply drive 22 is activated or not.

FIG. 4b differs from the solution according to FIG. 4a in that one of the supply modules, in this case supply module 20B, is selected as the so-called primary supply module 20p, which means that it is fixed, i.e., non-detachably, mechanically operatively connected to the supply drive 22.

A controllable clutch 23 is provided at most in the module-specific drive trains AsA-AsD of the other supply modules 20A, 20C, 20D, namely one clutch 23 in each module-specific drive train AsA-AsD.

The design of FIG. 4c differs from that of FIG. 4b in that the supply modules 20C and 20D are mechanically permanently operatively connected, i.e., such a clutch 23 is provided at most between the operative connection point of these two drive trains of the supply modules 20C and 20D and the next higher-level connection point VS of two drive trains in the direction of the supply drive 22, usually the branch from the main drive train Ah.

As a result, the two modules 20C and 20D can only be or become decoupled from or coupled to the supply drive 22 together by means of this clutch 23.

### LIST OF REFERENCES

1 Slicing machine, slicer
1* Control
2 Base frame
3 Blades
3 Rotation axis
3″ Blade plane, cutting plane
3a Cutting edge
4 Supply conveyor, supply belt
5 Cutting frame
6a-d Product opening
7 Cutting unit
8 Driven upper product guide, upper guide belt
8.1 Contact run, lower run
8a Blade-side deflecting roller
8b Deflecting roller facing away from the blade
9 Driven lower product guide, lower guide belt

What is claimed is:

1. A slicing machine for slicing at least one caliber into slices, comprising:
a cutting unit having a blade,
a supply unit for supplying a caliber to the cutting unit in a supply direction, comprising
as a first supply module, a gripper unit which is drivable in the supply direction and has at least one gripper for holding a rear end of the caliber facing away from the blade,
as a second supply module, a supply conveyor, which is drivable in the supply direction, for bearing against an underside of the caliber, and
as a third supply module, an upper product guide or a lower product guide, which is drivable in the supply direction, for bearing against an upper side or a lower side of the caliber,
wherein a mechanical operative connection of at least two of the first, second and third supply modules is provided.

2. The slicing machine according to claim 1, wherein the mechanical operative connection operatively connects at least three of the supply modules.

3. The slicing machine according to claim 1, wherein
the third supply module comprises the upper product guide, and the slicing machine further comprises the lower product guide as a fourth supply module,
wherein the mechanical operative connection operatively connects all four supply modules, and
the supply unit comprises only one supply drive for all four supply modules.

4. The slicing machine according to claim 1, further comprising:
a supply drive operable to drive a main drive train, to which the respective supply modules are operatively connected at a connection point, and
an individually controllable clutch provided between the connection point and a moving part of the respective supply module.

5. The slicing machine according to claim 1, further comprising a supply drive that is non-detachably mechanically coupled to one of the first, second or third supply modules, wherein the one of the first, second or third supply modules is a primary supply module.

6. The slicing machine according to claim 5, wherein the supply drive is non-detachably mechanically coupled to the second supply module.

7. The slicing machine according to claim 5, wherein the supply drive is operable to drive a main drive train, to which the supply modules are each operatively connected at a connection point, and wherein the supply unit further comprises a controllable clutch provided between the connection point of each respective supply module and a moving part of the respective supply module for all of the supply modules except the primary supply module.

8. The slicing machine according to claim 1, wherein the supply unit comprises a motor disposed upstream of the upper product guide or the lower product guide.

9. The slicing machine according to claim 1, wherein the mechanical operative connection is provided by one or more belt drives.

10. The slicing machine according to claim 9, wherein the one or more belt drives are disposed on an anti-operator side of the supply modules.

11. The slicing machine according to claim 1, wherein the second supply module or the third supply module comprises a slip sensor for detecting slip between a part of the supply module configured to engage the caliber and the caliber.

12. A method for operating a slicing machine having a supply unit with a plurality of supply modules which can cooperate to supply a caliber to be sliced to a cutting unit, the method comprising:
driving the supply modules in a supply direction,
wherein at least two of the supply modules are mechanically driven by a common supply drive.

13. The method according to claim 12, wherein at least three of the supply modules are mechanically driven by the common supply drive.

14. The method according to claim 12, wherein the plurality of supply modules comprises:
a first supply module including a gripper unit that is drivable in the supply direction and has at least one gripper for holding a rear end of the caliber facing away from a blade of the cutting unit,
a second supply module including a supply conveyor that is drivable in the supply direction, for bearing against an underside of the caliber, and
a third supply module including an upper product guide or a lower product guide, which is drivable in the supply direction, for bearing against an upper side or a lower side of the caliber.

15. The method according to claim 14, wherein the first, second and third supply modules are mechanically driven by the common supply drive.

16. The method according to claim 12, wherein the plurality of supply modules includes four supply modules, and the four supply modules are mechanically driven by the common supply drive.

17. The method according to claim 12, wherein the supply modules are decoupled individually or in groups from the supply drive or are operatively connected thereto, depending on an operating state of the slicing machine.
